(19) United States
(12) Patent Application Publication
(10) Pub. No.: US 2006/0145816 A1
(43) Pub. Date: Jul. 6, 2006

(54) Identification data storage medium and method

(76) Inventor: Werner Koele, Graz (AT)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/236,023

(22) Filed: Sep. 27, 2005

(30) Foreign Application Priority Data
Sep. 27, 2004 (DE) 10 2004 046 865.6

(51) Int. Cl. H04Q 5/22; G06Q 30/00; G08B 13/14

(52) U.S. Cl. 340/10.2; 340/572.1; 235/385

(57) ABSTRACT

One embodiment of the invention relates to an identification data storage medium, having a substrate, having an antenna formed on the substrate, having an integrated circuit formed on the substrate and is coupled to the antenna. The integrated circuit is designed such that the antenna produces an acknowledgement signal in response to a message that is received by means of the antenna and is addressed to the identification data storage medium.

### CROSS-REFERENCE TO RELATED APPLICATIONS

This Utility Patent Application claims priority to German Patent Application No. DE 10 2004 046 865.6, filed on Sep. 27, 2004, which is incorporated herein by reference.

### BACKGROUND

One embodiment of the invention relates to an identification data storage medium, to a read apparatus, to an identification system and to a method for operation of an identification system.

Identification marks are used to identify people or objects in many fields of daily life. According to the prior art, identification marks based on barcodes are used, although these are labor-intensive and thus expensive in use, since they must be read using an optical read apparatus, which has to be operated by the user. In addition, barcode systems cannot be used sensibly in many fields of application for identification marks (for example for theft protection systems in department stores).

“Radio Frequency Identification Tags” (RFID Tags) are suitable for applications such as these. An RFID tag normally contains an antenna, a circuit for reception and transmission of electromagnetic waves (transponder) and a signal processing circuit. An RFID tag such as this is thus frequently formed on a small silicon chip, which is connected to an antenna which is mounted on a plastic mount.

An RFID tag makes it possible to read and store data without any contact being made. Data such as this is stored on RFID tags (clearly electronic labels). The stored data is read by means of electromagnetic waves which can be injected into the RFID tag via the antenna.

RFID tags are thus small transponders which can be read by radio and are formed from a memory chip and a separate antenna. A unique electronic product code (EPC) can in each case be stored in the memory chip, with the prospect of replacing the current conventional 13-digit EAN barcode (“European Article Number”). Each individual product throughout the world can be provided with a unique number by means of the EPC code.

Many German and foreign companies from the retail sector are planning to use RFID technologies in the supplier area. The volume of investment just in the USA is estimated to be 1.3 billion US dollars by the year 2008, see “C”t—Magazin für Computer und Technik” [“C”t—Magazine for Computers and Technology], Heise Zeitschriften Verlag, Issue 3/2004, page 46.

In order to achieve a large turnover volume, it is important for the communication between a reader and identification data storage medium to be carried out reliably and without interference.

Each identification data storage medium is identified on a worldwide basis by a unique tag, a so-called UID (“Unique Identifier”).

In an identification system with a reader and a plurality of transponders, it is possible for an incorrect UID to be detected when a plurality of identification data storage media (transponders) respond at the same time. Parasitic artifacts can clearly occur as a result of undesirable superimposition of individual waves from the identification data storage media (by means of which individual waves of each of the identification data storage media transmits its UID to a reader). Such parasitic wave superimpositions can simulate for a reader the presence of a UID and thus of an identification data storage medium which in fact is not in the detection area of a reader at all.

According to the prior art, such false UIDs are not identified, or are identified only incorrectly. It is thus possible for UIDs which are actually not present to be indicated in a reader. For example, it has been observed experimentally that, when there are thirty identification data storage media actually present in the area of influence of a reader, thirty-one identification data storage media are incorrectly identified.

An identification system including a reader and at least one identification data storage medium is described in the Industry Standard ISO 15693 or ISO 18000.3-1, see ISO 15693, Parts 1-3, Contactless integrated circuits cards, ISO 18000.3, RFID for Item Management—Air Interface, Part 3—Parameters for Air interface at 13.56 MHz .

ISO 15693 allows error correction by means of a cyclic redundancy check (CRC) method, that is, by means of an algorithm that can be used to systematically construct a code word from a given message. In poor cases, however, in the presence of a plurality of identification data storage medium resulting from superimposition of a plurality of response signals, this leads to a response which is incorrectly regarded as being protected and valid, despite the CRC method.

ISO 15693 describes an anticollision method, in which an inventory instruction is first of all used to identify individual transponders, after which a StayQuiet instruction is sent for switching to the quiet state. An identification data storage medium (transponder) which is switched to the quiet state subsequently ignores instructions until it is returned to an active state. Since the reader of an identification data storage medium does not have the capability to check whether an identification data storage medium which has been switched to the StayQuiet state and has already been identified is actually present, or whether the associated UID is merely an artifact of the superimposition of waves from other identification data storage media, it is possible on the basis of the prior art for a reader to identify a plurality of identification data storage media, although one or more of the identification data storage media with incorrectly determined UIDs are not included in the field at all.

### SUMMARY

One embodiment of the invention provides a capability for a reader to more reliably identify an identification data storage medium. An identification data storage medium according to one embodiment of the invention includes a substrate, an antenna, which is formed on and/or in the substrate, and an integrated circuit, which is formed on and/or in the substrate and is coupled to the antenna. The integrated circuit is designed such that the antenna produces an acknowledgement signal in response to a message which is received by means of the antenna and is addressed to the identification data storage medium.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to-scale relative to each other. Like reference numerals designate corresponding similar parts.

FIG. 1 illustrates a polling protocol for a read apparatus according to one embodiment of the invention.

FIG. 2 and FIG. 3 illustrate response protocols for an identification data storage medium according to one embodiment of the invention for the situation of incorrect processing and for the situation of correct processing of the polling protocol illustrated in FIG. 1.

FIG. 4 illustrates an identification system according to one exemplary embodiment of the invention.

FIG. 5 illustrates a state diagram in states which an identification data storage medium according to one embodiment of the invention can assume.

FIG. 6 illustrates a polling protocol for a read apparatus according to one embodiment of the invention.

FIG. 7 illustrates a response protocol for an identification data storage medium according to one embodiment of the invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

According to one embodiment of the invention, a read apparatus is provided for communication with an identification data storage medium, having an electromagnetic radiation source which is designed to transmit electromagnetic radiation which can be received by an identification data storage medium, having a detection device for detection of electromagnetic radiation which is transmitted from an identification data storage medium, and having a control unit which is designed in such a way that it can provide the electromagnetic radiation source with a control signal for transmission of a message that is addressed specifically to one identification data storage medium, in such a way that the specifically addressed identification data storage medium is requested to send an acknowledgement signal, which can be detected by the detection device, in response to the message.

Furthermore, an identification system is provided according to one embodiment of the invention, which has at least one identification data storage medium with the features described above and has a read apparatus with the features described above for communication with the identification data storage medium.

Furthermore, a method for operation of an identification system is provided according to one embodiment of the invention, wherein the identification system has at least one identification data storage medium with the features described above and has a read apparatus with the features described above for communication with the identification data storage medium. In the method, the electromagnetic radiation source sends a message which is specifically addressed to one identification data storage medium, which requests the specifically addressed identification data storage medium to send an acknowledgement signal in response to the message. The identification data storage medium sends an acknowledgement signal, which is detected by the detection device, in response to the received message.

One embodiment of the invention implements a communication protocol for communication between identification data storage media and a reader in such a way that an acknowledgement or confirmation signal (“acknowledgement”) is sent back from the addressed identification data storage medium to the reader in response to a command or a message from a read apparatus, which is used to address one quite specific identification data storage medium. This unambiguously informs the read apparatus that the single identification data storage medium addressed by that command is actually physically present in the area of influence of the reader. This makes it possible to identify when the read apparatus has incorrectly identified an identification storage medium which is actually not present at all with an electrical field as being present. This is because, if no acknowledgement signal can be detected in response to the command from the reader which is addressing one and only one unitary identification data storage medium (for example by the command containing its UID), the read apparatus can deduce from this that the determined identification data storage medium is actually not present at all in the electrical field. According to one embodiment of the invention, this considerably improves the error robustness of the system including identification data storage media and a read apparatus, since this avoids erroneous identification of a UID resulting from the parasitic superimposition of electromagnetic waves from different identification data storage medium, in that, once a UID has been found, it is possible to reliably verify whether an identification data storage medium associated with that UID is or is not actually present.

In the context of ISO 15693 (or ISO 18000.3-1), a response to a command (for example to a StayQuiet command) from a reader can be sent from an addressed identification data storage medium to the read apparatus containing, for example, the UID of the addressed identification data storage medium. According to one embodiment of the invention, it is thus possible to eliminate the identification of incorrect serial numbers (UIDs) of RFID transponders since, after identification of a UID, an associated identification data storage medium can be addressed by the reader and is requested to send a confirmation signal. An identification data storage medium can send a confirmation signal such as this only if it is actually physically present. On receiving a confirmation signal, the reader classifies the verified identification data storage medium as being physically present. Otherwise, the previously identified UID can be classified as being incorrect, or at least imaginary. If required, an additional monitoring method can be used (for example manually) to check whether an identification data storage medium which has been classified as being incorrect or as imaginary is actually not present in the area of influence of the reader.

The command from the reader, in response to the reception of which the corresponding identification data storage medium sends a response, may have any desired content. By way of example, a command such as this may be a StayQuiet instruction, by means of which the reader switches a specific identification data storage medium to a rest state in which the identification data storage medium does not react to further commands until it is reactivated again. Before changing to the rest state, the identification data storage medium to which the command is addressed also sends a positive confirmation signal, which indicates to the reader that the identification data storage medium has actually received the command.

According to one embodiment of the invention, an Option_flag can be added to the StayQuiet instruction, by way of example. A response is sent from the identification data storage medium to the reader in response to a StayQuiet instruction. An identification data storage medium can thus send a positive acknowledgement to a reader when the identification data storage medium changes to the quiet state. This method is compatible with a StayQuiet instruction, which has already been defined in the Industry Standards ISO 15693 and ISO 18000.3-1, for the purposes of these Standards. This does not envisage an Option_flag, which can be implemented according to one embodiment of the invention.

In one method according to one embodiment of the invention identification is made of incorrect (additional and not actually present) UIDs by a reader. By way of example, this reader can send a StayQuiet instruction in response to a received UID. This is responded to by an acknowledgement when the identification data storage medium is actually present. If no response is received, this transponder is not present, and the UID is ignored. The invention thus improves the reliability for determination of those identification data storage media which are located in an electrical field of a read apparatus.

One embodiment of the invention uses the addition of the StayQuiet instruction to allow unambiguous identification of all of the RFID transponders in an antenna field of an RFID reader. The method according to one embodiment of the invention allows quick and reliable identification. This therefore avoids undesirable identification of additional UIDs, which are physically not present, by the RFID reader.

The implementation of a confirmation signal from an identification data storage medium in reaction to a previously transmitted command from the reader thus eliminates incorrect UIDs, makes it possible to check whether an identification data storage medium is (still) in the area of influence of the reader, allows such a check to be carried out more quickly than in accordance with the ISO Standard, and is completely compatible with ISO 18000.3-1, that is, it can be implemented completely within the scope of this Industry Standard. An Option_flag which includes the request to send a confirmation signal may be provided as part of the flag structure in the communication protocol of the reader.

According to one embodiment of the invention, an RFID tag can in its own right send an acknowledgement to any desired command which uniquely addresses the respective RFID tag. The setting of an Option_flag and the request to send a confirmation signal in reaction to a StayQuiet command represents one embodiment of the invention.

The identification, according to one embodiment of the invention, of an incorrectly identified UID, that is, of an identification data storage medium which has been detected but is not actually present, can be carried out at high speed. Fast transponder identification leads to a system such as this having a high performance. This allows faster anticollision checking and evaluation in the system according to one embodiment the invention.

An RFID tag which is in a quiet state can also respond once again to a corresponding command from the reader, so that the reader can be used to check whether an identification data storage medium which is in the area of influence of the reader is still present. The command can be used to send a response signal for example on changing from a ready state to a quiet state, on changing from a select state to a quiet state, or in the case of a command for the identification data storage medium to remain in a quiet state which it has already assumed, with this response signal including information that the identification data storage medium with unitary UID is in the electrical field.

In summary, one aspect of the invention is that a reader first of all determines the UIDs of all the identification data storage media which are in its area of influence, in which case the determined UIDs may also include parasitic UIDs. The reader can then send a quite specific command to the determined identification data storage medium, with this command being directed solely to this unitary identification data storage medium (but not to all the other identification data storage media), for example by addressing the unitary identification data storage medium by means of its UID, which is unique throughout the world. The command includes the request to the identification data storage medium to send back a confirmation signal to the reader, including a unique coding of which identification data storage medium has sent the confirmation signal. When the reader receives a confirmation signal such as this, it can deduce from this that an identification data storage medium with the associated UID is actually within the area of influence of the reader. Otherwise, the UID can be classified as being parasitic. If the reader repeats the cycle of transmission of a command and detection of a confirmation signal with each individual one of the determined identification data storage media, then it is possible to verify in an interference proof manner which identification data storage media are and are not actually present. In addition to the request to send a confirmation signal, the command may include an additional request, for example a request to the identification data storage medium to change to a quiet state.

The following text describes developments of the identification data storage medium according to embodiments of the invention, which also apply to the read apparatus, to the identification system and to the method for operation of an identification system.

The integrated circuit can be designed in such a way that the identification data storage medium changes to a rest state and the antenna produces an acknowledgement signal in response to a message which is received by means of the antenna and is addressed to the identification data storage medium to the effect that the identification data storage medium should change to a rest state.

In other words, according to this embodiment, the integrated circuit is designed in such a way that it changes to a StayQuiet state and the antenna produces a signal for sending an acknowledgement signal in response to a StayQuiet command which is received by the antenna and is specifically addressed to the identification data storage medium. According to this embodiment, the command thus includes a StayQuiet command which changes the associated identification data storage medium to a rest state, in which the identification data storage medium remains deactivated, and ignores subsequent signals, until it is reactivated. An identification data storage medium which is in the quiet state can be reactivated by another control signal from the read apparatus, for example by being changed to a ready state or to a select state. In a ready state, the RFID tag can be received again for commands, and the RFID tag is selected in a select state.

The StayQuiet command changes only that identification data storage medium which is addressed uniquely in this way to the rest state. The command is thus uniquely matched to one and only one identification data storage medium throughout the world, with the attached request to send a confirmation signal also being uniquely matched to one and only one identification data storage medium throughout the world. All of the other identification data storage media to which other unitary UIDs are allocated react neither to the StayQuiet command nor to the request to send a confirmation signal.

The integrated circuit in the identification data storage medium can be designed in such a way that a unique identification tag for unique identification of the identification data storage medium is coded in the acknowledgement signal.

Thus, according to this refinement, the acknowledgement signal obviously contains the UID, that is, the identification tag which is allocated uniquely throughout the world to that identification data storage medium. The read apparatus which has decoded the identification tag from a transmitted signal can thus unambiguously identify that the identified identification data storage medium with the respective UID is actually in the area of influence of that read apparatus.

In the case of the identification data storage medium, the integrated circuit can be designed in such a way that the antenna produces a signal for transmission of an acknowledgement signal when the message which is addressed specifically to that identification data storage medium contains a unique identification tag for unique identification of that identification data storage medium.

According to this refinement, the identification data storage medium sends the confirmation signal back to the read apparatus only when the command is directed unambiguously and exclusively to this identification data storage medium, especially when the command unambiguously addresses that identification data storage medium on the basis of its UID.

The identification data storage medium may have a device for attachment of the identification data storage medium to an object, and in one case to a product package.

A device such as this may, for example, be an adhesive joint or some other connection between the identification data storage medium and a package for a product, or on a product itself. The product to which the identification data storage medium can be fitted can thus be uniquely identified throughout the world, by means of the UID. Information which can be read about the product, for example a price of the product or other product information, can also be stored in a memory device in the identification data storage medium. Information such as this can be read by the reader.

The identification data storage medium may be in the form of a radio frequency identification tag (RFID tag) which, can be operated in the 13.56 MHz frequency band.

Fields of use for an RFID tag such as this are electronic goods protection systems in order to prevent theft, automation applications (for example automatic identification of vehicles in a traffic system or for toll systems), access monitoring systems, cashless payment, ski passes, refueling cards, animal identification and applications in lending libraries.

The identification data storage medium may be in the form of an identification data storage medium in accordance with ISO 15693 and may operate completely compatibly with this Industry Standard.

The identification data storage medium may be designed in such a way that, on reception of the command, it changes from a ready-to-operate state (Ready state) to a rest state (StayQuiet state), from a selected state (Select state) to a rest state (StayQuiet state) or from one rest state (StayQuiet state) to another rest state (StayQuiet state).

In other words, a command need not necessarily switch the identification data storage medium from an active state (Ready state, Select state) to the StayQuiet state, and a StayQuiet→StayQuiet command can also be sent.

Refinements of the read apparatus according to embodiments of the invention will be described in the following text, and these also apply to the identification data storage medium, to the identification system and to the method for operation of an identification system.

In the case of the read apparatus, the control unit can be designed in such a way that the electromagnetic radiation source produces a control signal for transmission of a message which can be received by an identification data storage medium to the effect that the identification data storage medium should change to a rest state, which message is addressed specifically to one identification data storage medium.

The detection device can be designed in such a way that it decodes a unique identification tag from the acknowledgement signal for unique identification of the identification data storage medium.

The read apparatus may be designed in accordance with ISO 15693.

Refinements of the identification system according to embodiments of the invention will be described in the following text, and these also apply to the identification data storage medium, to the read apparatus and to the method for operation of an identification system.

The identification system in one case has a plurality of identification data storage media. In the case of a system such as this including a read apparatus and a plurality of identification data storage media, the acknowledgement signal which is requested according to one embodiment of the invention can be used to allow high-reliability verification of each individual one of the identification data storage media. In other words, an identified UID can be used to verify whether an identification data storage medium which is associated with this UID is or is not actually present in the area of influence of the read apparatus.

The identification system can be designed in such a way that it can identify each of at least some of the identification data storage media in that the read apparatus identifies a unique identification tag for unique identification of an identification data storage media of each of the at least some of the identification data storage media, and identifies a possibly incorrectly identified identification tag by transmitting a message to the possibly associated identification data storage media by detecting an acknowledgement signal which may then be sent by the identification data storage medium, and by using the presence or absence of the acknowledgement signal to decide whether an identified identification tag is classified as being incorrect.

According to this refinement, each individual one of the identification data storage media can be identified as being error-robust.

According to one exemplary embodiment of the invention, an extension to the StayQuiet instruction is applied to an ISO 15693 (ISO 18000.3-1)-compatible transponder.

The transponder can identify the StayQuiet instruction by an activated Option_flag, and can send a response to the request directed to it from the reader. The system extension according to one embodiment of the invention can be implemented in an integrated circuit in the RFID. The extension is likewise implemented in an RFID reader, in order to allow the transponder or transponders to respond correctly.

According to the described exemplary embodiment, the following extensions are in addition to a StayQuiet instruction as defined in ISO 15693.

In an active state, the transponder sends a response when it receives a valid StayQuiet command. The response is sent only when an option_flag is set.

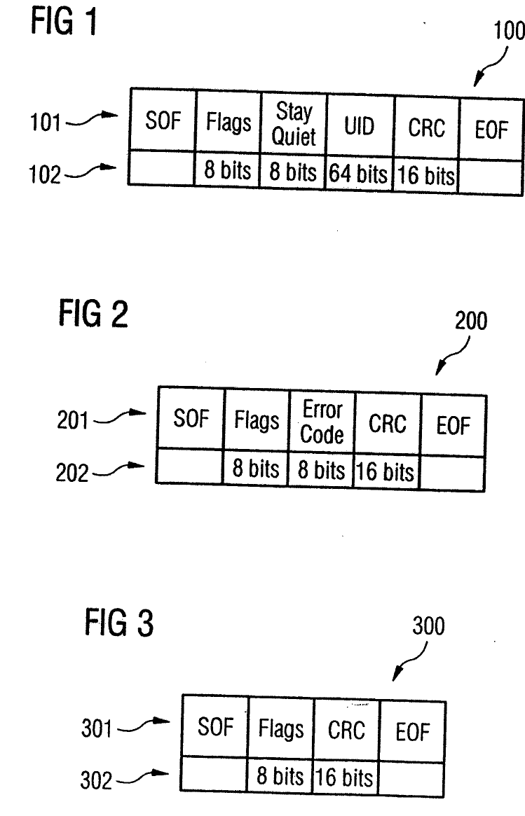

A polling format 100 for a read apparatus according to one embodiment of the invention will be described in the following text with reference to FIG. 1.

FIG. 1 illustrates a plurality of polling sections 101, each of which is associated with a respective data set 102.

The polling protocol 100 starts with an SOF (start of frame) polling section. After this, a flag section with a length of 8 bits is transmitted, and is followed by a StayQuiet section with a length of 8 bits. If an appropriate flag is set in the flag section, then a transponder to which the polling protocol 100 is directed is requested to send a confirmation signal. In a transponder to which the polling protocol is directed, the StayQuiet section causes the transponder to change to a rest state. After this, a UID section with a length of 64 bits is transmitted containing a UID, which is unique throughout the world, for an addressed transponder. The UID section is followed by a CRC polling section with a length of 16 bits. The last polling section is an EOF (end of frame) polling section.

The following text refers to FIG. 2 to describe a response format 200 for an identification data storage medium (RFID tag), as is transmitted to a read apparatus in the event of a negative acknowledgement of a StayQuiet instruction from the identification data storage medium, when an error has occurred.

In other words, an acknowledgement is produced in accordance with the response protocol 200 illustrated in FIG. 2 by an RFID tag that is addressed by the read apparatus by means of a unitary UID when an error occurs during the processing of the polling protocol 100 in the RFID tag, as illustrated in FIG. 1.

The response format 200 includes a plurality of response sections 201, with respective associated data sets 202.

A SOF (start of frame) response section is followed by a flag response section with a length of 8 bits, which is followed by an ErrorCode response section, with a length of 8 bits. This is followed by a CRC response section with a length of 16 bits, before an EOF (end of frame) response section is provided at the end of the response format 200. The information that an error has occurred during the processing of the polling protocol 100 in the RFID tag is coded in the ErrorCode response section.

The following text refers to FIG. 3 to describe a response format 300 which is used to produce a positive acknowledgement to a StayQuiet instruction.

A plurality of response sections 301 are provided in the response format 300, each of which has an associated data set 302.

A flag response section with a length of 8 bits follows, followed by an SOF (start of frame) response section, after which there is a CRC response section with a length of 16 bits. An EOF (end of frame) response section is located at the end of this response format 300.

The response format 300 is transmitted by an RFID tag, which has previously received and processed without any error a command addressed specifically to this RFID tag, in accordance with the polling protocol 100. The RFID tag thus confirms receipt of the command, and in this way informs the reader of the presence of the RFID tag.

Thus, according to one embodiment of the invention, a transponder sends a response to a StayQuiet command with an activated Option_flag.

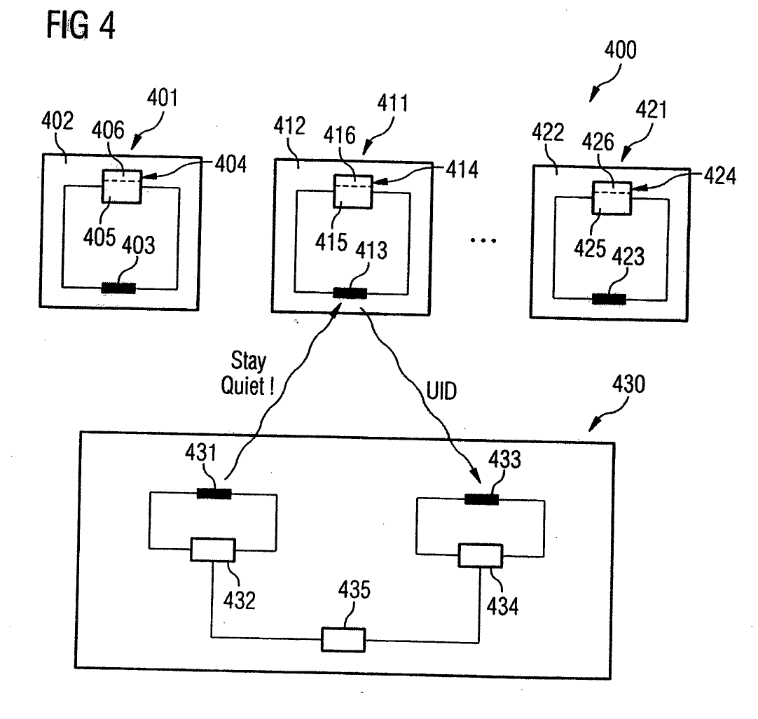

The following text refers to FIG. 4 in order to describe an identification system 400 according to one exemplary embodiment of the invention.

The identification system 400 includes a first RFID tag 401, a second RFID tag 411, . . . and an n-th RFID tag 421. A read apparatus 430 is also provided, and can communicate with the RFID tags 401, 411, . . . , 421.

The first identification data storage medium 401 contains a first plastic mount 402 on which a first antenna 403 and a first monolithically integrated CMOS circuit 404, which is coupled to it, are fitted. The monolithically integrated first integrated circuit 404, which is produced using silicon technology, contains a first control unit 405 and a first EEPROM (electrically erasable and programmable read only memory) 406. A UID (Unique Identifier) for the first RFID tag 401, that is, an identification for the first RFID tag 401 that is unique throughout the world, is stored in the first EEPROM memory 406. When electrical energy is injected into the first RFID tag 401 via the first antenna 403, then the first control unit 405 can thus be operated. This first control unit 405 detects a received signal and processes it in which case, if required, a signal can be transmitted from the first antenna, controlled by the first control unit 405.

The second RFID tag 411 is designed in a similar way to the first RFID tag 401, and contains a second plastic mount 412, a second antenna 413, a second integrated circuit 414, a second control unit 415 and a second EEPROM memory 416. Furthermore, an n-th RFID tag 421 is provided, which is designed in a similar way to the first RFID tag 401 and to the second RFID tag 411, and which has an n-th plastic mount 422, an n-th antenna 423, an n-th integrated circuit 424, an n-th control unit 425 and an n-th EEPROM memory 426.

A UID which is unique throughout the world is stored in each of the RFID tags 401, 411, . . . , 421, in which case the read apparatus 430 can cause a signal to be sent from each of the RFID tags 401, 411, . . . , 421 by sending a first signal. The read apparatus 430 can use the signals transmitted from the RFID tags 401, 411, . . . , 421 to determine the UIDs which are associated with the respective RFID tags 401, 411, . . . , 421.

The read apparatus 430 contains a transmission coil 431, by means of which electromagnetic radiation can be transmitted, and can be received by a respective one of the RFID tags 401, 411, . . . , 421. The electromagnetic waves which are transmitted from the transmission coil 431 are controlled by a transmission signal generator 432, which generates the transmission signal and provides this to the transmission coil 431. The operation of the transmission signal generator 432 is controlled by the control device 435.

Furthermore, the read apparatus 430 contains a receiving coil 433 for receiving electromagnetic radiation which is emitted from a respective one of the RFID tags 401, 411, . . . , 421. This received electromagnetic radiation can be passed to a detection unit 434, which can decode information coded in the signal. This information can be passed from the detection unit 434 to the control device 435.

The operation of the identification system 400 will be described in the following text.

When the read apparatus 430 wishes to identify RFID tags 401, 411, . . . , 421 located in its area of influence, it does this by sending a corresponding signal to the respective RFID tags 401, 411, . . . , 421. In a corresponding manner to the operation of the control units 405, 415, . . . , 425, the RFID tags 401, 411, . . . , 421 then send an electromagnetic signal which contains the respective UID as information, as stored in the respective EEPROM memory 406, 416, 426. These signals can be received by the receiving coil 433, and can be decoded by the detection unit 434.

When there are a large number of RFID tags 401, 411, . . . , 421 in the area of influence of the read apparatus 430, it is possible for additional UIDs, for which no corresponding RFID tag is actually physically present at all, to be detected as a result of parasitic wave superimposition of the electromagnetic waves, as emitted by the individual RFID tags 401, 411, . . . , 421, in the read apparatus 430. According to the prior art, this can lead to erroneous identification of UIDs.

The invention now allows unique identification of all the RFID tags 401, 411, . . . , 421 which are in the area of influence of the read apparatus 430, and avoids incorrect identification of UIDs. This is done by verifying each individual one of the RFID tags 401, 411, . . . , 421 after identification of all of the UIDs.

As described below, it is possible to verify for a determined RFID tag 401, 411, . . . , 421 whether this RFID tag 401, 411, . . . , 421 is actually in the area of influence of the read apparatus 430, or whether this is just an artifact. Once the read apparatus 430 has first of all determined the UIDs of all of the RFID tags 401, 411, . . . , 421 in its area of influence, in which case the determined UIDs may also include parasitic UIDs, the read apparatus 430 then sends to a quite specific one of the determined RFID tags 401, 411, . . . , 421 a command which is directed solely to this unitary RFID tag 401, 411, . . . , 421 (but not to all of the other RFID tags 401, 411, . . . , 421). One specific RFID tag 401, 411, . . . , 421 is selected by addressing the unitary RFID tag 401, 411, . . . , 421 by means of its UID, which is unique throughout the world. The command includes the request to the RFID tag 401, 411, . . . , 421 to send back a confirmation signal to the read apparatus 430, including unique coding of which RFID tag 401, 411, . . . , 421 has sent the confirmation signal. When the read apparatus 430 receives a confirmation signal such as this, then it can use this to deduce that an RFID tag 401, 411, . . . , 421 with the associated UID is actually physically contained in the area of influence of the read apparatus 430. Otherwise, the UID can be classified as being parasitic. The read apparatus 430 then repeats the cycle of transmission of a command and detection of a confirmation signal with each individual one of the determined RFID tags 401, 411, . . . , 421. It is thus possible in an interference-proof manner to verify which of the determined RFID tags 401, 411, . . . , 421 are actually present and which are not. According to the described exemplary embodiment, in addition to the request to transmit a confirmation signal, the command includes a StayQuiet command to the respective RFID tag 401, 411, . . . , 421, with the request to change to a quiet state.

Incorrectly determined UIDs can thus be reliably eliminated, according to one embodiment of the invention.

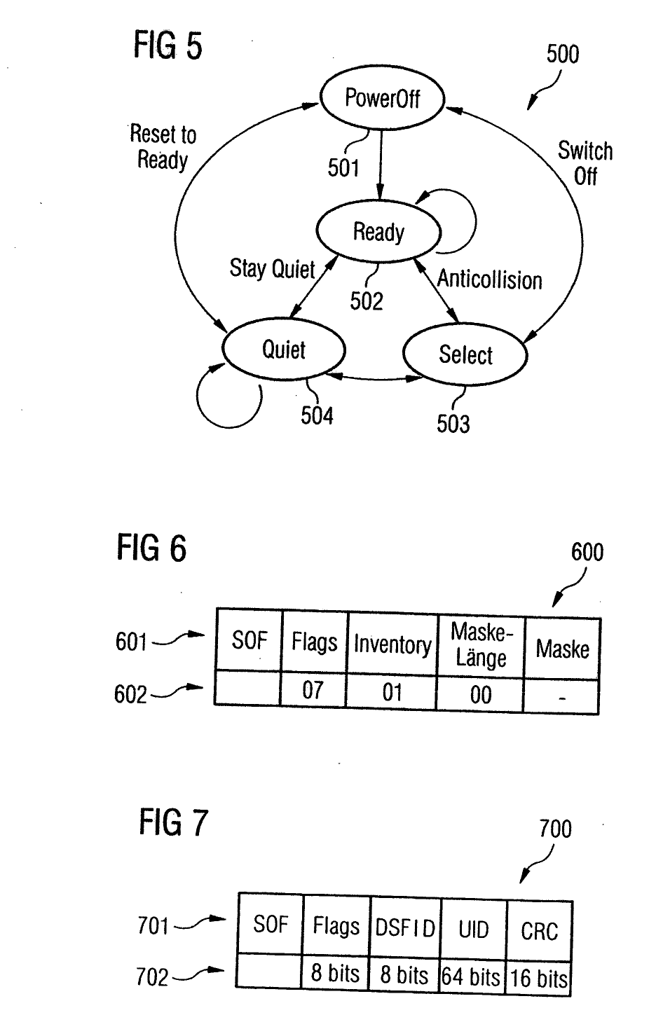

The following text refers to FIG. 5 to describe a diagram 500 which illustrates schematically possible operating states of an RFID tag for an identification system, and changes between the operating states, which can be initiated by means of appropriate control signals from a read apparatus.

FIG. 5 illustrates a power-off state 501, in which an identification data storage medium is in a switched-off state. The RFID tag can be changed from this power-off state 501 to a ready state 502 by means of an appropriate command signal, with the RFID tag being ready to operate in this ready state 502. Starting from the ready state, a StayQuiet signal can be used to change the RFID tag to a quiet stage 504, in which it is deactivated until further notice, and ignores signals from then on. An RFID tag which is in the quiet state does not change back again to an active state until a reactivation signal has been received. Starting from the ready state 502, the RFID tag can be changed to a select state 503 by means of an appropriate anticollision signal. It is also possible for the identification data storage medium to be changed from the select state 503 to the quiet state 504, or to the power-off state 501. A change between the quiet state 504 and the power-off state 502 can be carried out by means of a reset-to-ready signal. When changing from the select state 503 to the power-off state 501, the corresponding RFID tag is removed from the electromagnetic field area of a read apparatus.

The following text refers to FIG. 6 to describe a polling protocol 600, which can be directed to a tag from a read apparatus, in an inventory phase.

FIG. 6 illustrates a plurality of polling sections 601 and the corresponding data sets 602. In the inventory check illustrated in FIG. 6, an SOF (start of frame) polling section is followed by a flag polling section, followed by an inventory polling section, after which a mask length is transmitted, followed by a mask.

The mask length and the mask are implemented within an anticollision method.

The following text refers to FIG. 7 to describe a response protocol 700 which can be sent from an RFID tag to a read apparatus, with the response format 700 having a plurality of response sections 701 with associated data sets 702.

An SOF (start of frame) response section is followed by a flag response section with a length of 8 bits, followed by a DSFID (data storage format identifier), which is followed by a UID response section with a length of 64 bits, which is followed by a CRC response section with a length of 16 bits.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An identification data storage medium, comprising:
a substrate;
an antenna formed on the substrate; and
an integrated circuit formed on the substrate and coupled to the antenna;
wherein the integrated circuit is configured such that the antenna produces an acknowledgement signal in response to a message that is received by means of the antenna and is addressed to the identification data storage medium.

2. The identification data storage medium of claim 1, wherein the integrated circuit is configured such that, in response to a message which is received by means of the antenna and is addressed to the identification data storage medium, the identification data storage medium changes to a rest state, the identification data storage medium changes to a rest state and the antenna produces an acknowledgement signal.

3. The identification data storage medium of claim 1, wherein the integrated circuit is configured such that a unique identification tag for unique identification of its identification data storage medium is coded in the acknowledgement signal.

4. The identification data storage medium of claim 1, wherein the integrated circuit is configured such that the antenna produces a signal for transmission of an acknowledgement signal when the message that is addressed specifically to the identification data storage medium contains a unique identification tag for unique identification of the identification data storage medium.

5. The identification data storage medium of claim 1, further comprising a device for attachment of the identification data storage medium to an object.

6. The identification data storage medium of claim 1, configured as a radiofrequency identification tag.

7. The identification data storage medium of claim 1, configured as an identification data storage medium in accordance with ISO 15693.

8. The identification data storage medium of claim 1, configured such that, in response to reception of the message, it changes from one of a group comprising a ready-to-operate state to a rest state, a selected state to a rest state, and one rest state to another rest state.

9. A read apparatus for communication with an identification data storage medium, comprising:
an electromagnetic radiation source configured to transmit electromagnetic radiation that can be received by an identification data storage medium;
detection means for detecting electromagnetic radiation that is transmitted from an identification data storage medium; and
a control unit configured such that it provides the electromagnetic radiation source with a control signal for transmission of a message that is addressed specifically to one identification data storage medium, in such a way that the specifically addressed identification data storage medium is requested to send an acknowledgement signal, which can be detected by the detection means, in response to the message.

10. The read apparatus of claim 9, wherein the control unit is configured such that it provides the electromagnetic radiation source with a control signal for sending a message that can be received by the identification data storage medium, that the identification data storage medium changes to a rest state, which message is addressed specifically to one identification data storage medium.

11. The read apparatus of claim 9, wherein the detection means is configured such that it decodes a unique identification tag from the acknowledgement signal for unique identification of the identification data storage medium.

12. The read apparatus of claim 9, configured as a read apparatus in accordance with ISO 15693.

13. An identification system, comprising:
at least one identification data storage medium comprising:
a substrate;
an antenna formed on the substrate; and
an integrated circuit formed on the substrate and coupled to the antenna;
wherein the integrated circuit is configured such that the antenna produces an acknowledgement signal in response to a message that is received by means of the antenna and is addressed to the identification data storage medium;
a read apparatus for communication with the identification data storage medium, the read apparatus comprising:
an electromagnetic radiation source configured to transmit electromagnetic radiation that can be received by an identification data storage medium;
detection means for detecting electromagnetic radiation that is transmitted from an identification data storage medium; and
a control unit configured such that it provides the electromagnetic radiation source with a control signal for transmission of a message that is addressed specifically to one identification data storage medium, in such a way that the specifically addressed identification data storage medium is requested to send an acknowledgement signal, which can be detected by the detection means, in response to the message.

14. The identification system of claim 13, further comprising a plurality of identification data storage media.

15. The identification system of claim 14, configured such that it can identify each of at least some of the identification data storage media in that the read apparatus identifies a unique identification tag for unique identification of an identification data storage media of each of the at least some of the identification data storage media; identifies a possibly incorrectly identified identification tag by transmitting a message to the possibly associated identification data storage media by detecting an acknowledgement signal which may then be sent by the identification data storage medium, and by using the presence or absence of the acknowledgement signal to decide whether an identified identification tag is classified as being incorrect.

16. A method for operation of an identification system, wherein the identification system has:
at least one identification data storage medium comprising:
a substrate;
an antenna formed on the substrate; and
an integrated circuit formed on the substrate and coupled to the antenna;
wherein the integrated circuit is configured such that the antenna produces an acknowledgement signal in response to a message that is received by means of the antenna and is addressed to the identification data storage medium;
a read apparatus for communication with the identification data storage medium, comprising:
an electromagnetic radiation source configured to transmit electromagnetic radiation that can be received by an identification data storage medium;
detection means for detecting electromagnetic radiation that is transmitted from an identification data storage medium; and
a control unit configured such that it provides the electromagnetic radiation source with a control signal for transmission of a message that is addressed specifically to one identification data storage medium, in such a way that the specifically addressed identification data storage medium is requested to send an acknowledgement signal, which can be detected by the detection means, in response to the message; wherein, the method comprises:
sending a message with the electromagnetic radiation source that is specifically addressed to one identification data storage medium, which requests the specifically addressed identification data storage medium to send an acknowledgement signal in response to the message; and
sending an acknowledgement signal with the identification data storage medium, which is detected by the detection device, in response to the received message.
